(19) United States
(12) Patent Application Publication
(10) Pub. No.: US 2010/0251176 A1
(43) Pub. Date: Sep. 30, 2010

(54) VIRTUAL KEYBOARD WITH SLIDER BUTTONS

(75) Inventors: Jeffrey Fong, Seattle, WA (US); John David Kittell, Seattle, WA (US); Bryan Nealer, Seattle, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/410,286

(22) Filed: Mar. 24, 2009

(51) Int. Cl. G06F 3/048

(52) U.S. Cl. 715/821; 715/833; 345/173

(57) ABSTRACT

A computing system includes a touch display and a virtual keyboard visually presented by the touch display. The virtual keyboard includes one or more slider buttons, and each slider button includes a plurality of touch-selectable items. The computing system further includes a touch-detection module configured to recognize which of the plurality of touch-selectable items is being touched, and a visual-feedback module configured to visually indicate that a touch-selectable item is considered to be ready for selection responsive to that touch-selectable item being touched. The computing system also includes a selection module configured to input a touch-selectable item responsive to a touch lifting from that touch-selectable item while the visual-feedback module visually indicates that touch-selectable item is considered to be ready for selection.

### BACKGROUND

Computing devices have been designed with various different input mechanisms that allow a computer user to issue commands and/or input data. While portable devices continue to become more popular, user expectations have increased with respect to the usability and functionality of portable input mechanisms.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

Various embodiments related to virtual keyboards with slider buttons are disclosed herein. For example, one disclosed embodiment provides for a computing system that includes a touch display and a virtual keyboard visually presented by the touch display. The virtual keyboard includes one or more slider buttons, and each slider button includes a plurality of touch-selectable items. The computing system further includes a touch-detection module configured to recognize which of the plurality of touch-selectable items is being touched, and a visual-feedback module configured to visually indicate that a touch-selectable item is considered to be ready for selection responsive to that touch-selectable item being touched. The computing system also includes a selection module configured to input a touch-selectable item responsive to a touch lifting from that touch-selectable item while the visual-feedback module visually indicates that touch-selectable item is considered to be ready for selection.

### BRIEF DESCRIPTION OF THE DRAWINGS

FIG. 1 shows a handheld computing system visually presenting a virtual keyboard with slider buttons.

FIG. 2 shows a touch sequence in which a visual-feedback module visually indicates that a touch-selectable item is considered to be ready for selection.

FIG. 3 shows another touch sequence in which a visual-feedback module visually indicates that a touch-selectable item is considered to be ready for selection.

FIG. 4 shows a touch sequence in which an alternative-selection module changes a touched slider button to include a different plurality of touch-selectable items.

FIG. 5 schematically shows a computing system configured to visually present a virtual keyboard with slider buttons.

FIG. 6 shows a method of processing user input in accordance with embodiments of the present disclosure.

### DETAILED DESCRIPTION

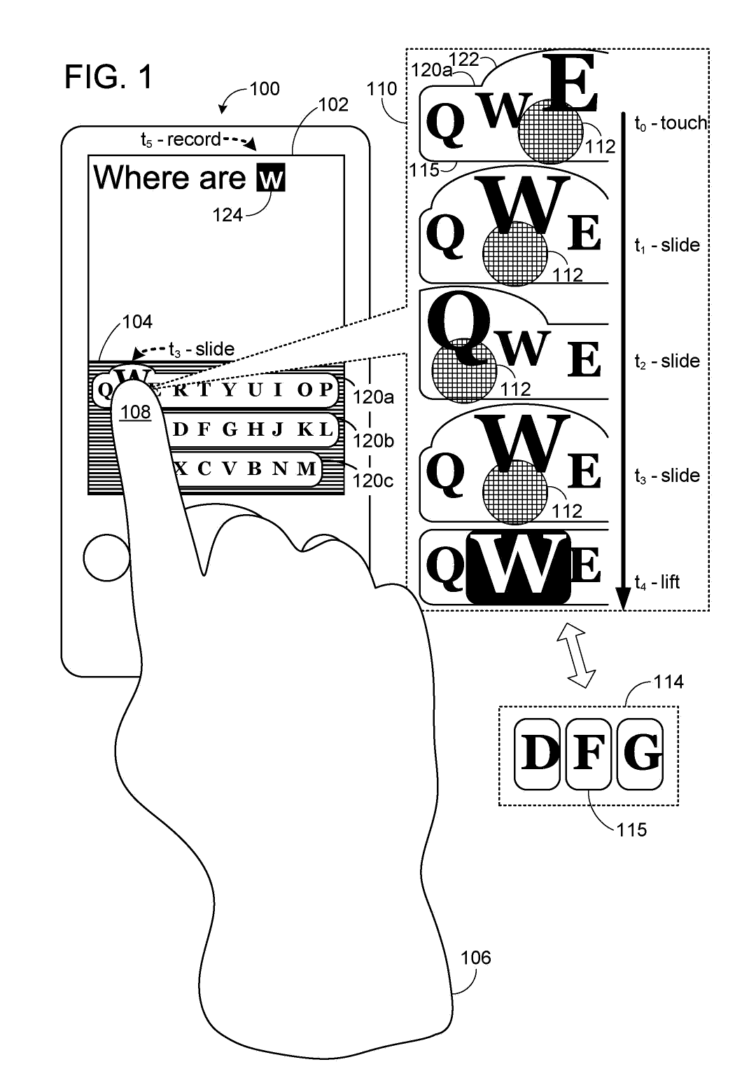

FIG. 1 shows a handheld computing system 100 that includes a touch display 102 visually presenting a virtual keyboard 104. Virtual keyboard 104 serves as a portable input mechanism that allows a user 106 to issue commands and/or input data by touching touch display 102. As an example, a user (e.g., user 106) may touch a touch-selectable item (e.g., the W-item) of virtual keyboard 104 in order to cause data associated with that touch-selectable item (e.g., ASCII “W”) to be recognized as input from the user.

As described in detail below, virtual keyboard 104 includes slider buttons (e.g., first slider button 120a, second slider button 120b, and third slider button 120c) that may facilitate user input. As an example, in embodiments in which the virtual keyboard has a relatively small size, slider buttons may reduce keying errors resulting from large fingers, or other objects used to effectuate touch input, accidentally striking a touch-selectable item that is not intended to be struck. As an example, as shown in FIG. 1, user 106 is touching virtual keyboard 104 with finger 108. As shown at time t₀ of touch sequence 110, a touch region 112 of finger 108 is overlapping a portion of the E-item. On a relatively small virtual keyboard, it may be difficult to touch only one touch-selectable item at a time. Furthermore, it may be difficult to touch an intended touch-selectable item before touching unintended touch-selectable items and/or to lift a finger from an intended touch-selectable item after first lifting the finger from all other unintended touch-selectable items. As such, it may be difficult for a computing device to accurately resolve which touch-selectable item the user is intending to strike.

As described below, visually grouping two or more touch-selectable items in a common slider button provides a user with an indication that a touch input may be slid across the slider button in order to carefully choose a particular one of the two or more touch-selectable items. To emphasize the sliding capability of the slider button, the individual touch-selectable items can be displayed as borderless touch-selectable items anchored interior a continuous and visually distinct boundary of the slider button. For purposes of comparison, a portion of a virtual keyboard that includes individual keys that are visually separated from one another by visually distinct boundaries around each key is shown at 114. As shown at 114, in addition to each key having an individual and visually distinct boundary 115, rows of such keys are not grouped together as part of a slider button. It is believed that virtual keyboards with individual keys signal that touch input for each key is separate from and independent of touch input for all other keys, while a slider button signals cooperative touch input for all of the touch-selectable items anchored within the slider button. It is believed that a user is much more likely to intuitively learn to slide a touch to carefully select a desired touch-selectable item when touch-selectable items are collectively grouped within a slider button. As such, it is believed that slider buttons can decrease user inefficiency and/or frustration resulting from unintentional key striking.

While FIG. 1 uses handheld computing system 100 as an example platform for illustrating the herein described concepts, it is to be understood that a virtual keyboard with slider buttons may be implemented on a variety of different computing devices including a touch display. The present disclosure is not limited to handheld computing devices.

Furthermore, the present disclosure is not limited to the example virtual keyboard embodiments illustrated and described herein. Virtual keyboard 104 comprises a first slider button 120a including a left-to-right arrangement of a Q-item, a W-item, an E-item, an R-item, a T-item, a Y-item, a U-item, an I-item, an O-item, and a P-item; a second slider button 120b comprising a left-to-right arrangement of an A-item, an S-item, a D-item, an F-item, a G-item, an H-item, a J-item, a K-item, and an L-item; and a third slider button 120c comprising a left-to-right arrangement of a Z-item, an X-item, a C-item, a V-item, a B-item, an N-item, and an M-item. Virtual keyboards may be designed with a variety of different key arrangements, key shapes, key sizes, and/or other parameters without departing from the spirit of this disclosure.

Touch sequence 110 shows a time-elapsed sequence in which a user is touching first slider button 120a. At time t₀, the user touches the E-item anchored within first slider button 120a, as indicated by touch region 112. The computing system is configured to visually indicate that a touch-selectable item is considered to be ready for selection by changing the appearance of the slider button.

As one example, a touch-selectable item that is touched may be magnified on touch display 102. For example, the E-item is magnified at time t₀ of touch sequence 110. The magnified size of the E-item visually indicates that the E-item is considered to be ready for selection (i.e., if the user lifts the finger, the E-item will be selected for input). Furthermore, one or more neighboring touch-selectable items may be magnified. At time t₀, the W-item is magnified, though not as much as the E-item. Magnifying neighboring touch-selectable items may further indicate that a touch may be slid across the slider button to select different touch-selectable items.

Touch sequence 110 demonstrates how the appearance of the virtual keyboard changes as a user slides a touch across the slider button. For example, at time t₁, touch region 112 has slid to touch the W-item, and the W-item is magnified to indicate that the W-item is considered to be ready for selection. At time t₂, touch region 112 has slid to touch the Q-item, and the Q-item is magnified to indicate that the Q-item is considered to be ready for selection. At time t₃, touch region 112 has slid back to touch the W-item, and the W-item is again magnified to indicate that the W-item is again considered to be ready for selection. This type of visual feedback allows a user to carefully choose which touch-selectable item will be input. In some embodiments, each touch-selectable item from a selected slider button may be magnified by a different amount. As an example, a touch-selectable item that is considered ready for selection may be magnified by a greatest amount, and a relative amount of magnification of other touch-selectable items in the same slider button may decrease as a distance from the touch-selectable item considered ready for selection increases.

As another example, a position of a touch-selectable item that is touched may be shifted on touch display 102 to visually indicate that that touch-selectable item is considered to be ready for selection. For example, a position of the E-item is vertically shifted at time t₀ of touch sequence 110. The shifted position of the E-item visually indicates that the E-item is considered to be ready for selection (i.e., if the user lifts the finger, the E-item will be selected for input). Furthermore, one or more neighboring touch-selectable items may be positionally shifted. At time t₀, the W-item is shifted vertically, though not as much as the E-item. Shifting a position of neighboring touch-selectable items may further indicate that a touch may be slid across the slider button to select different touch-selectable items. In some embodiments, each touch-selectable item from a selected slider button may be shifted by a different amount. As an example, a touch-selectable item that is considered ready for selection may be shifted by a greatest amount, and a relative amount of shifting of other touch-selectable items in the same slider button may decrease as a distance from the touch-selectable item considered ready for selection increases.

As another example, a continuous and visually distinct boundary of the slider button can be expanded to accommodate a magnified size and/or a shifted position of a touch-selectable item. For example, touch sequence 110 shows an expansion 122 of the continuous and visually distinct boundary 115. Expansion 122 dynamically shifts with the magnified and positionally shifted touch-selectable items as touch region 112 slides across slider button 120a. Shifting a position of expansion 122 may further indicate that a touch may be slid across the slider button to select different touch-selectable items.

At t₅ of touch sequence 110, user 106 lifts finger 108, and the W-key is input because it is the last touch-selectable item considered to be ready for selection. As shown at 124, at time t₅, after time t₄, the touch display may display a W-character in response to the W-key being selected and input. In some embodiments, the computing system may visually indicate that a touch-selectable item is considered to be ready for selection by displaying a character corresponding to the touch-selectable item considered to be ready for selection at a location exterior the virtual keyboard, as shown at 124. In other words, the character displayed in a workspace exterior the keyboard may dynamically change as a user slides a finger across a slider button. Such a character may be locked into place when the user lifts a finger from the touch display.

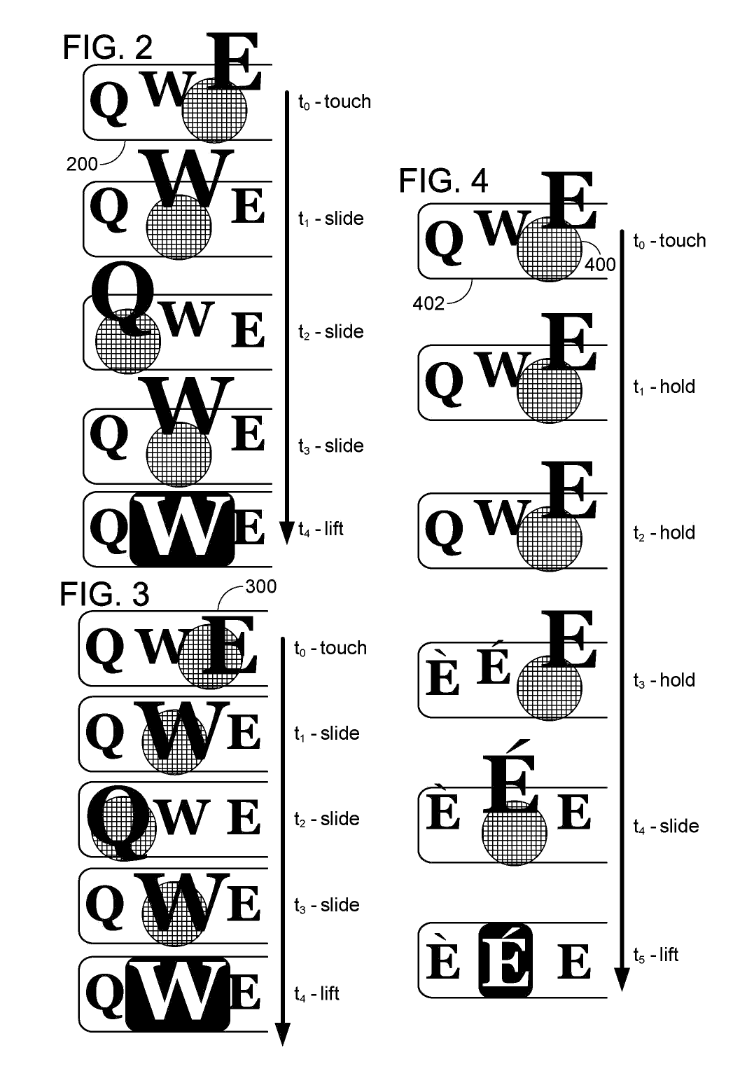

FIG. 1 shows an example in which a touch-selectable item is magnified and shifted while a continuous and distinct boundary of the slider button expands. In some embodiments, one or more of these forms of visual feedback may be used in the absence of other forms of visual feedback. As an example, FIG. 2 shows a portion of a slider button 200 using visual feedback in the form of magnification and shifting without boundary expansion. As another example, FIG. 3 shows a portion of a slider button 300 using visual feedback in the form of magnification without shifting or boundary expansion. It is to be understood that various different types of visual feedback can be used, independently or cooperatively, to visually indicate that a touch-selectable item is considered to be ready for selection.

As shown in FIG. 4, a touched slider button may change to include a different plurality of touch-selectable items linked to the touch-selectable item previously considered to be ready for selection. For example, a user may touch and holds an E-item from time t₀ to time t₃, as indicated by touch region 400 of FIG. 4. When a touch of the touch-selectable item considered to be ready for selection exceeds a threshold duration (e.g., t₃−t₀) slider button 402 changes to include a variety of different E-items with different accents. As shown at times t₄ and t₅, a user may then slide a touch across the changed slider button to select a desired E-item with a desired accent, and lift the touch to input that item. It is to be understood that virtually any child touch-selectable items may be linked to a parent touch-selectable item so that the child items may be accessed by touching and holding the parent item.

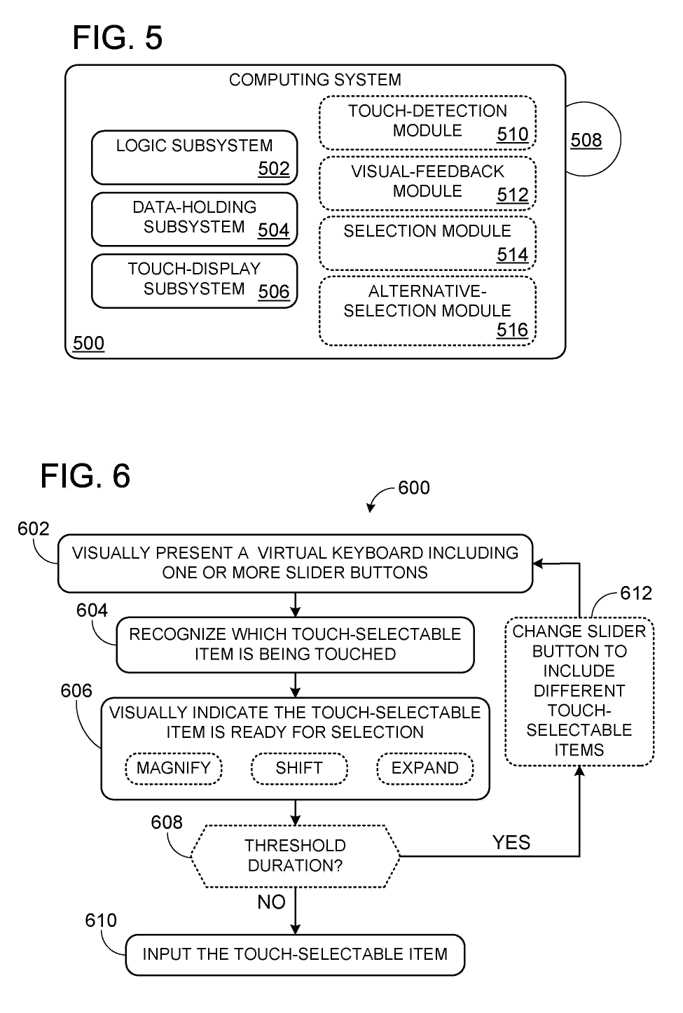

In some embodiments, the herein described methods and processes for visually presenting a virtual keyboard and/or processing touch input directed to the virtual keyboard may be tied to a computing system. As an example, FIG. 5 schematically shows a computing system 500 that may perform one or more of the herein described methods and processes. Computing system 500 includes a logic subsystem 502, a data-holding subsystem 504, and a touch-display subsystem 506.

Logic subsystem 502 may include one or more physical devices configured to execute one or more instructions. For example, the logic subsystem may be configured to execute one or more instructions that are part of one or more programs, routines, objects, components, data structures, or other logical constructs. Such instructions may be implemented to perform a task, implement a data type, transform the state of one or more devices, or otherwise arrive at a desired result. The logic subsystem may include one or more processors that are configured to execute software instructions. Additionally or alternatively, the logic subsystem may include one or more hardware or firmware logic machines configured to execute hardware or firmware instructions. The logic subsystem may optionally include individual components that are distributed throughout two or more devices, which may be remotely located in some embodiments.

Data-holding subsystem 504 may include one or more physical devices configured to hold data and/or instructions executable by the logic subsystem to implement the herein described methods and processes. When such methods and processes are implemented, the state of data-holding subsystem 504 may be transformed (e.g., to hold different data). Data-holding subsystem 504 may include removable media and/or built-in devices. Data-holding subsystem 504 may include optical memory devices, semiconductor memory devices, and/or magnetic memory devices, among others. Data-holding subsystem 504 may include devices with one or more of the following characteristics: volatile, nonvolatile, dynamic, static, read/write, read-only, random access, sequential access, location addressable, file addressable, and content addressable. In some embodiments, logic subsystem 502 and data-holding subsystem 504 may be integrated into one or more common devices, such as an application specific integrated circuit or a system on a chip.

FIG. 5 also shows an aspect of the data-holding subsystem in the form of computer-readable removable media 508, which may be used to store and/or transfer data and/or instructions executable to implement the herein described methods and processes.

Touch-display subsystem 506 may be used to present a visual representation of data held by data-holding subsystem 504 (e.g., present a virtual keyboard). As the herein described methods and processes change the data held by the data-holding subsystem, and thus transform the state of the data-holding subsystem, the state of touch-display subsystem 506 may likewise be transformed to visually represent changes in the underlying data. Furthermore, touch-display subsystem 506 may be used to recognize user input in the form of touches. Such touches may be positionally correlated to an image presented by the touch-display subsystem and assigned different meaning depending on the position of the touch. Touch-display subsystem 506 may include one or more touch-display devices utilizing virtually any type of display and/or touch-sensing technology. Such touch-display devices may be combined with logic subsystem 502 and/or data-holding subsystem 504 in a shared enclosure, or such touch-display devices may be peripheral touch-display devices.

Logic subsystem 502, data-holding subsystem 504, and touch-display subsystem 506 may cooperate to visually present a virtual keyboard with slider buttons. Furthermore, the logic subsystem and the data-holding subsystem may cooperate to form a touch-detection module 510; a visual-feedback module 512; a selection module 514; and/or an alternative-selection module 516.

The touch-detection module 510 may be configured to recognize which of the plurality of touch-selectable items is being touched.

The visual-feedback module 512 may be configured to visually indicate that a touch-selectable item is considered to be ready for selection responsive to that touch-selectable item being touched, as described above.

The selection module 514 may be configured to input a touch-selectable item responsive to a touch lifting from that touch-selectable item while the visual-feedback module visually indicates that touch-selectable item is considered to be ready for selection, as described above.

The alternative-selection module 516 may be configured to change a touched slider button to include a different plurality of touch-selectable items. The different plurality of touch-selectable items may be linked to the touch-selectable item previously considered to be ready for selection. In some embodiments, the alternative-selection module 516 may be configured to change the touched slider button responsive to a touch of the touch-selectable item previously considered to be ready for selection exceeding a threshold duration.

FIG. 6 shows a method 600 of processing user input. At 602, method 600 includes visually presenting with a touch display a virtual keyboard including one or more slider buttons, each slider button including a plurality of touch-selectable items. At 604, method 600 includes recognizing which of the plurality of touch-selectable items is being touched. At 606, method 500 includes visually indicating that a touch-selectable item is considered to be ready for selection responsive to that touch-selectable item being touched. At 608, method 500 may optionally include determining if a touch-selectable item has been considered to be ready for selection for at least a threshold duration. If the touch-selectable item has been considered to be ready for selection for at least a threshold duration, the method flows back to 602, and the touched slider button is changed to include a different plurality of touch-selectable items at 612. If the touch-selectable item has not been considered to be ready for selection for at least a threshold duration, the method proceeds to 610. At 610, method 600 includes inputting a touch-selectable item responsive to a touch lifting from that touch-selectable item while the visual-feedback module visually indicates that touch-selectable item is considered to be ready for selection.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A computing system, comprising:
a touch display;
a virtual keyboard visually presented by the touch display, the virtual keyboard including one or more slider buttons, each slider button including a plurality of touch-selectable items;
a touch-detection module configured to recognize which of the plurality of touch-selectable items is being touched;
a visual-feedback module configured to visually indicate that a touch-selectable item is considered to be ready for selection responsive to that touch-selectable item being touched; and
a selection module configured to input a touch-selectable item responsive to a touch lifting from that touch-selectable item while the visual-feedback module visually indicates that touch-selectable item is considered to be ready for selection.

2. The computing system of claim 1, where each of the plurality of touch-selectable items is a borderless touch-selectable item anchored interior a continuous and visually distinct boundary of a slider button.

3. The computing system of claim 1, where each of the plurality of touch-selectable items is a touch-selectable letter.

4. The computing system of claim 1, where the virtual keyboard comprises:
a first slider button including a left-to-right arrangement of a Q-item, a W-item, an E-item, an R-item, a T-item, a Y-item, a U-item, an I-item, an O-item, and a P-item;
a second slider button comprising a left-to-right arrangement of an A-item, an S-item, a D-item, an F-item, a G-item, an H-item, a J-item, a K-item, and an L-item; and
a third slider button comprising a left-to-right arrangement of a Z-item, an X-item, a C-item, a V-item, a B-item, an N-item, and an M-item.

5. The computing system of claim 1, where the visual-feedback module is configured to visually indicate that a touch-selectable item is considered to be ready for selection by magnifying that touch-selectable item.

6. The computing system of claim 5, where the visual-feedback module is configured to visually indicate that a touch-selectable item is considered to be ready for selection by magnifying a neighboring touch-selectable item of the touch-selectable item considered to be ready for selection.

7. The computing system of claim 5, where the visual-feedback module is configured to visually indicate that a touch-selectable item is considered to be ready for selection by expanding a visually distinct boundary of a slider button to accommodate a magnified size of one or more touch-selectable items.

8. The computing system of claim 1, where the visual-feedback module is configured to visually indicate that a touch-selectable item is considered to be ready for selection by shifting a position of that touch-selectable item.

9. The computing system of claim 8, where the visual-feedback module is configured to visually indicate that a touch-selectable item is considered to be ready for selection by shifting a position of a neighboring touch-selectable item of the touch-selectable item considered to be ready for selection.

10. The computing system of claim 8, where the visual-feedback module is configured to visually indicate that a touch-selectable item is considered to be ready for selection by expanding a visually distinct boundary of a slider button to accommodate a shifted position of one or more touch-selectable items.

11. The computing system of claim 1, including an alternative-selection module configured to change a touched slider button to include a different plurality of touch-selectable items, the different plurality of touch-selectable items linked to the touch-selectable item previously considered to be ready for selection.

12. The computing system of claim 11, where the alternative-selection module is configured to change the touched slider button responsive to a touch of the touch-selectable item previously considered to be ready for selection exceeding a threshold duration.

13. The computing system of claim 1, where the visual-feedback module is configured to visually indicate that a touch-selectable item is considered to be ready for selection by displaying a character corresponding to the touch-selectable item considered to be ready for selection at a location exterior the virtual keyboard.

14. A handheld computing system, comprising:
a touch display;
a virtual keyboard visually presented by the touch display, the virtual keyboard including one or more slider buttons having a continuous and visually distinct boundary, each slider button including a plurality of borderless touch-selectable items anchored interior the continuous and visually distinct boundary of the slider button;
a touch-detection module configured to recognize which of the plurality of touch-selectable items is being touched;
a visual-feedback module configured to visually indicate that a touch-selectable item is considered to be ready for selection by magnifying and shifting a position of that touch-selectable item and expanding the continuous and visually distinct boundary of the slider button to accommodate a magnified size and shifted position of that touch-selectable item responsive to that touch-selectable item being touched; and
a selection module configured to input a touch-selectable item responsive to a touch lifting from that touch-selectable item while the visual-feedback module visually indicates that touch-selectable item is considered to be ready for selection.

15. The handheld computing system of claim 14, where the virtual keyboard comprises:
a first slider button including a left-to-right arrangement of a Q-item, a W-item, an E-item, an R-item, a T-item, a Y-item, a U-item, an I-item, an O-item, and a P-item anchored interior the continuous and visually distinct boundary of the first slider button;
a second slider button comprising a left-to-right arrangement of an A-item, an S-item, a D-item, an F-item, a G-item, an H-item, a J-item, a K-item, and an L-item anchored interior the continuous and visually distinct boundary of the second slider button; and
a third slider button comprising a left-to-right arrangement of a Z-item, an X-item, a C-item, a V-item, a B-item, an N-item, and an M-item anchored interior the continuous and visually distinct boundary of the third slider button.

16. The handheld computing system of claim 14, where the visual-feedback module is configured to visually indicate that a touch-selectable item is considered to be ready for selection by displaying a character corresponding to the touch-selectable item considered to be ready for selection at a location exterior the virtual keyboard.

17. A method of processing user input, the method comprising:
visually presenting with a touch display a virtual keyboard including one or more slider buttons, each slider button including a plurality of touch-selectable items;
recognizing which of the plurality of touch-selectable items is being touched;
visually indicating that a touch-selectable item is considered to be ready for selection responsive to that touch-selectable item being touched; and
inputting a touch-selectable item responsive to a touch lifting from that touch-selectable item while the visual-feedback module visually indicates that touch-selectable item is considered to be ready for selection.

18. The method of claim 17, where visually indicating that a touch-selectable item is considered to be ready for selection includes magnifying that touch-selectable item.

19. The method of claim 17, where visually indicating that a touch-selectable item is considered to be ready for selection includes shifting a position of that touch-selectable item.

20. The method of claim 17, where visually indicating that a touch-selectable item is considered to be ready for selection includes expanding a visually distinct boundary of a slider button to accommodate a shifted position and/or magnified size of one or more touch-selectable items.
